(19) United States
(12) Patent Application Publication
(10) Pub. No.: US 2013/0217785 A1
(43) Pub. Date: Aug. 22, 2013

(54) COMPOSITE ANIMAL FEED COMPACT

(71) Applicant: Enginuity Worldwide, LLC, (US)

(72) Inventor: Robert L. Heimann, Columbia, MO (US)

(73) Assignee: Enginuity Worldwide, LLC, Columbia, MO (US)

(21) Appl. No.: 13/841,636

(22) Filed: Mar. 15, 2013

Related U.S. Application Data
(63) Continuation-in-part of application No. 13/018,211, filed on Jan. 31, 2011.

(51) Int. Cl. A23K 1/00

(52) U.S. Cl. CPC A23K 1/004
USPC 514/769; 426/635

(57) ABSTRACT

An animal feed compact is provided by the present disclosure that includes a body having a various feed composition and an adhesive additive. The adhesive additive includes a starch and a hydroxide. Further additives may also be provided, which include any edible/digestible alfalfa meal, sunflower meal grain, ruffage [roughage], soybean meal wheat mids, hay, stover, whey dicalcium phosphate, limestone molasses, minerals, vitamins and medication. Various geometries and compositions for the biomass fuel compact are also provided by the present disclosure.

### CROSS-REFERENCE TO RELATED APPLICATIONS

This application is a continuation-in-part application of U.S. application Ser. No. 13/018,211, filed on Jan. 31, 2011, which is based upon Provisional Patent Application Ser. No. 61/336,989, entitled “Improved Biomass Fuel Pellet,” filed Jan. 29, 2010, the contents of which are incorporated herein by reference in their entirety and continued preservation of which is requested. This application is also related to the application “Biomass Fuel Compact Processing Method” filed concurrently herewith, which is commonly assigned with the present application, and the contents of which are incorporated herein by reference in their entirety.

### FIELD

The present disclosure relates to animal feed. More specifically, the present disclosure relates to compositions and structures for improved quantity/quality of nutrients in feed compacts.

### BACKGROUND

The statements in this section merely provide background information related to the present disclosure and may not constitute prior art.

[USE PARAGRAPH FROM ANIMAL FEED COMPOSITION]

### SUMMARY

In one form of the present disclosure, an animal feed compact is provided that comprises a body having a nutrition composition and an adhesive additive, wherein the adhesive additive comprises a starch and a hydroxide.

In another form, a biomass fuel compact is provided that comprises an animal feed composition and an adhesive additive. The adhesive additive comprises at least one of a starch and a hydroxide.

In still another form, an animal feed compact is provided that comprises a body having a nutrients composition, an adhesive additive comprising a starch and vitamins, medications, and minerals.

In variations of these animal feed compacts, the hydroxide is selected from the group consisting of alkali metal hydroxides, alkaline earth hydroxides, sodium hydroxide, potassium hydroxide, calcium hydroxide, lithium hydroxide, and caustic soda. Further additives may also include a silicate additive, (which may be a liquid or powder form), vitamins, medications, and minerals. Additionally, various geometries and compositions for the animal feed compacts are also provided by the teachings of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of various geometric forms of a body of a feed compact constructed in accordance with the principles of the present disclosure; and

FIG. 2A is a perspective view of an alternate form of a body for the feed compact in accordance with the principles of the present disclosure;

FIG. 2B is a front view of the alternate form of the body for the feed compact of FIG. 2A accordance with the principles of the present disclosure; and

FIG. 2C is a side view of the alternate form of the body for the feed compact of FIG. 2A accordance with the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

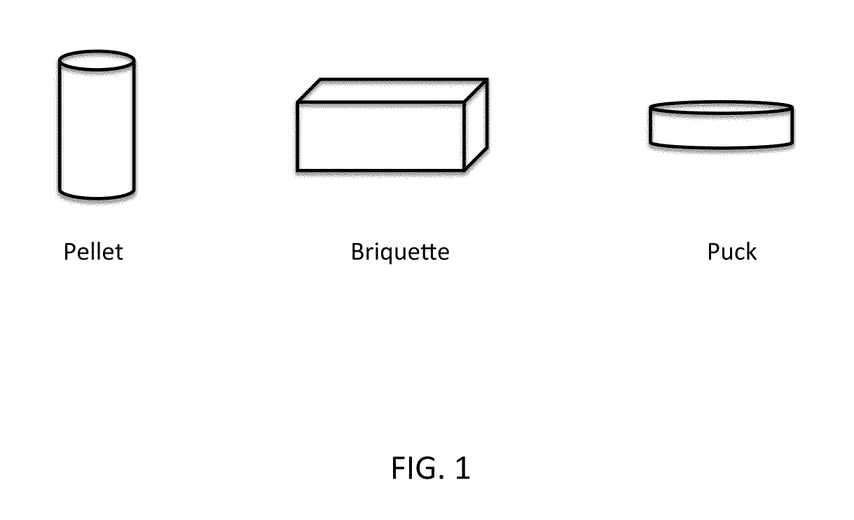

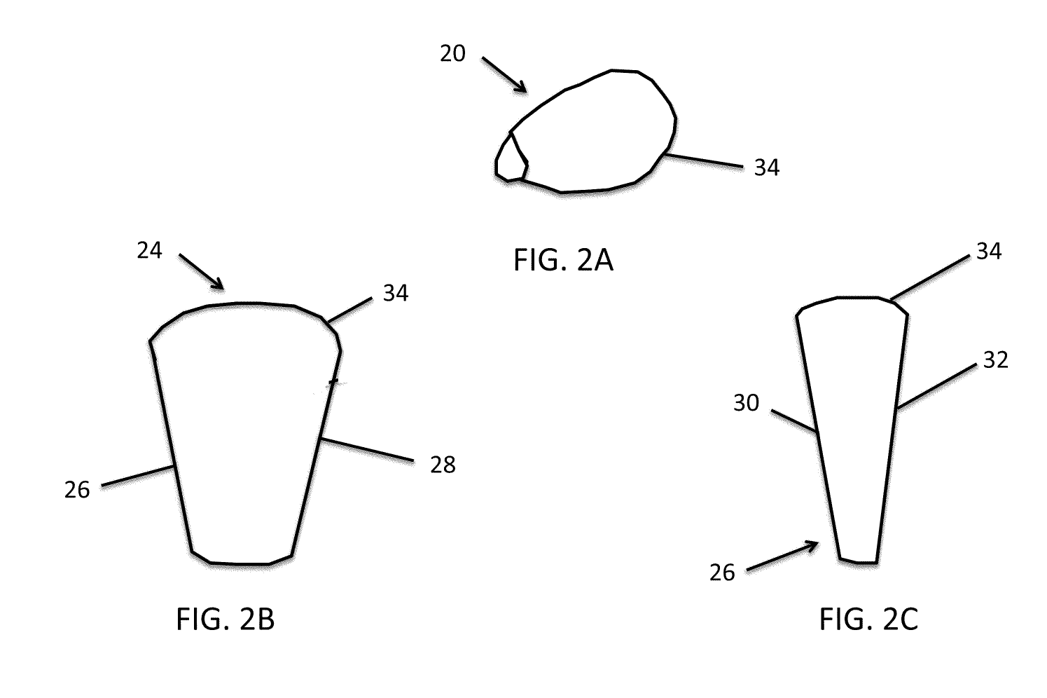

According to the principles of the present disclosure, an animal feed compact is provided that comprises a body, which may be in any shape or form, such as the exemplary forms shown in FIG. 1. As indicated, the body 10 may be in the form of a pellet, a briquette, range cube, or a puck. It should be understood that these geometric forms are merely exemplary and thus they should not be construed as limiting the scope of the present disclosure.

The body 10 comprises an animal feed composition that can essentially be any edible/digestible, or combination of feed stocks. By way of example, these materials may include grass, switchgrass, energy crops, hay, wheat straw, duckweed, mixed leaves, yard waste, agricultural waste, cotton waste, grape and wine offal, corn stover, crop stovers, tobacco waste, tea waste, food processing waste, food packaging waste, nut meats animal waste, and olive meal.

Advantageously, the feed compact is highly durable do to its inventive adhesive additive. Generally, the feed compact uses a Stein Hall type adhesive made from starch, or any other suitable material to replace the natural lignins as set forth above. In a Stein Hall adhesive, about 5% to 20% of the total starch content is gelatinized into a high viscosity paste called primary starch. The remainder of the starch (about 80% to 90%) stays ungelatinized and is called secondary starch. The starch may be one produced from wheat, oats, rice, corn, wheat middling, wheat waste or even wood and the like, but containing a gelatinized fraction that upon substantial drying will tightly bond the feed composition.

Additionally, the adhesive additive includes a hydroxide. The hydroxide may be, for example, alkali metal hydroxides, alkaline earth hydroxides, sodium hydroxide, potassium hydroxide, calcium hydroxide, lithium hydroxide, and caustic soda, among others. The synergistic combination of starch and hydroxide provide a highly durable biomass fuel compact, in which any number of constituent combustible materials may be used, without relying on any natural lignins or other undesirable binders.

In one form, the innovative adhesive is provided to bind the constituent feed composition and also to form a substantially continuous shell around the exterior portion of the fuel compact. With this shell, the biomass fuel compact according to the present disclosure is highly durable and significantly reduces the traditional dust waste issues associated with commercial feeds, as set forth above.

In one exemplary composition of the present disclosure, the feed compact comprises, by percent weight, about 69-98% biomass composition, about 1-30% starch, and less than 1% hydroxide. Another composition is about 90-95% biomass and about 5-10% of the inventive adhesive additive.

Further additives are also provided by the present disclosure, which may include, by way of example, [need text]

TABLE 1

| | Feeds | Starch | Hydroxide |
|---|---|---|---|
| Range | 50-90% | 5-50% | 0.005-0.05% |
| Target | 60 | 10 | 0.02 |

Generally, the body is modeled after a kernel of corn, which is has a hard outer shell, is transportable, has relatively flat sides, and an advantageous aspect ratio in order to be highly durable for handling and downstream operations.

As shown, the body 20 has an upper portion 22, a lower portion 24, and tapered sidewalls 26, 28, 30, and 32 extending from the upper portion 22 to the lower portion 24, wherein the upper portion 22 is wider than the lower portion 24. In one form, the body 20 comprises rounded edges 34 as shown, in order to provide increased durability. The tapered sidewalls 26 and 28 are generally parallel and opposed as shown, as are the tapered walls 30 and 32. At least one of the tapered sidewalls 26, 28, 30, and 32 defines a flat surface in one form of the present disclosure. It should be understood that this geometry, along with the pellet, puck, and briquette as previously set forth, are merely exemplary and should not be construed as limiting the scope of the present disclosure.

Accordingly, an animal feed compact is provided by the present disclosure that is durable, that reduces the amount of dust normally associated with known feed compositions, that is lower cost, higher efficiency, and reduces and/or improves weight gains, also known as feed efficiency. The innovative adhesive tends to not only bind the composite feed, but also to form a substantially continuous shell around the exterior of the compact, providing for a highly durable composite feed compact.

Various forms of composite biomass fuel compacts described herein were tested for durability per the American Society of Agricultural and Biological Engineering ASABE S269.4, December 1991 (R2007) Sec. 5 Durability test standard. A “GAMET” Pellet durability test was utilized to run the testing experiments for 10 minutes @50 rpm at room temperature. A Pellet Durability Index (PDI) was defined by dividing the weight of the compacts before and after testing. After testing, the compacts are screened and the remaining whole compacts are weighted. The starting weight is standardized at 500 grams. The PDI equals the remainder after testing divided by 500 multiplied by 100 to arrive at a percentage. The test results are as follows:
1. Switchgrass Puck, manufactured by local providers, without any adhesive—PDI=68.4.
2. Innovative composite biomass fuel compact according to the teachings of the invention—PDI =99.99. (Using saw dust)

BTU content was tested using a bomb calorimetry, Model IKA c2000 basic. The test method was ASTM D5865, standard test method for Gross Calorific value of Coal and Coke. Five variations of the innovative composite biomass fuel compact were tested for BTU content.

Additional information related to various forms of the present disclosure are shown in Appendix A, which is incorporated herein by reference in its entirety.

It should be noted that the invention is not limited to the various forms described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. An animal feed compact comprising:
a body comprising:
a composition; and
an adhesive additive comprising:
a starch; and
a hydroxide.

2. The feed compact according to claim 1, wherein the hydroxide is selected from the group consisting of alkali metal hydroxides, alkaline earth hydroxides, sodium hydroxide, potassium hydroxide, calcium hydroxide, lithium hydroxide, and caustic soda.

3. The feed compact according to claim 1 further comprising at least one of vitamins, minerals, and medicine materials.

6. The feed compact according to claim 1, [consisting of ?] any edible/digestible mix.

7. The feed compact according to claim 1 comprising, by percent weight:
69-98% biomass composition;
1-30% starch; and
less than 1% hydroxide.

8. The feed compact according to claim 1, wherein the body has an upper portion, a lower portion, and tapered walls extending from the upper portion to the lower portion, wherein the upper portion is wider than the lower portion.

9. The feed compact according to claim 8, wherein the body further comprises rounded edges.

10. The feed compact according to claim 1, wherein the body comprises parallel opposed sidewalls and parallel opposed end walls, and at least one of the sidewalls defines a flat surface.

11. The feed compact according to claim 1, wherein the body defines a range cube.

12. The feed compact according to claim 1, wherein the feed is selected from the group consisting of a pellet, a briquette, a range cube, and a puck.

13. An animal feed compact comprising:
any edible/digestible composition; and
an adhesive additive comprising at least one of a starch and a hydroxide.

14. The feed compact according to claim 13, wherein the hydroxide is selected from the group consisting of alkali metal hydroxides, alkaline earth hydroxides, sodium hydroxide, potassium hydroxide, calcium hydroxide, lithium hydroxide, and caustic soda.

15. The feed compact according to claim 13 further comprising medication, vitamins, and minerals.

17. The feed compact according to claim 13, wherein the biomass fuel compact comprises, by percent weight:
90 96% biomass; and
4-10% adhesive additive.

18. A feed compact comprising:
a body comprising:
an animal feed composition;
an adhesive additive comprising:
a starch; and
a hydroxide.

19. The feed compact according to claim 18, wherein the biomass fuel compact comprises, by percent weight:
50-95% biomass;
5-50% starch;
0.005-0.05% hydroxide;
0.1-5% vitamins; and
0.1 minerals, medication.
